(19) United States
(12) Patent Application Publication
(10) Pub. No.: US 2004/0086711 A1
(43) Pub. Date: May 6, 2004

(54) Pressure sensitive package sealing tape with reinforcing tear strip and dispensing method

(76) Inventors: Kenneth Backman, Chesire, CT (US); Robert Collins, Trumbull, CT (US); George John LeMoine, Trumbull, CT (US); Philip L. White, Prospect, CT (US)

Correspondence Address: PERMAN & GREEN, 425 POST ROAD, FAIRFIELD, CT, 06824, US

(21) Appl. No.: 10/288,708

(22) Filed: Nov. 5, 2002

(51) Int. Cl. B32B 7/12

(52) U.S. Cl. 428/354; 428/343

(57) ABSTRACT

A package closure tape assembly includes a laminate layer having a pressure sensitive adhesive and a reinforcing strip for reinforcing the laminate layer, for increasing a resistance to tearing during package handling by a user, and for providing a tear strip to separate the laminate layer.

### BACKGROUND OF THE INVENTION

1. Field of the Invention

The present invention relates to a system for sealing packages and, more particularly, to a a tape dispensing apparatus and a tape dispensed from the dispensing apparatus including a laminate layer having a pressure sensitive adhesive and a reinforcing strip

2. Prior Art

There are many methods known in the prior art for closing open seams on packages, such as for example envelopes, and cartons, in order to facilitate storage, and shipping, as well as provide security for items inside the packages. Some methods use gummed paper tape for sealing seams on envelopes, or flaps on packages. These methods use gummed paper tape because of the ruggedness, and consistency of the seals formed with gummed paper tape. However, in the prior art, when desired to open cartons or packages thus sealed, some implement will typically be used because of the strength of the seal, to break through the tape and release the carton flaps. The implement may be a knife, a simple door key, a pen or even finger nails. Opening a carton is considered, by most end users, to be an inconvenience at best but may also result in injuries to the user, and damage to the carton contents by virtue of the implement penetrating too deep thereby cutting or marring the contents. The present invention overcomes the problems of the prior art as will be described in greater detail below.

### SUMMARY OF THE INVENTION

In accordance with a first embodiment of the present invention, a package closure tape assembly includes a laminate layer having a pressure sensitive adhesive and a reinforcing strip for reinforcing the laminate layer, for increasing a resistance to tearing during package handling by a user, and for providing a tear strip to separate the laminate layer.

In accordance with a second embodiment of the present invention, a method for closing a package includes providing a laminate layer with a pressure sensitive adhesive and a reinforcing strip, and applying the laminate layer on an open seam of the package wherein the reinforcing strip provides user indicia to aid in aligning the laminate layer with the open seam.

In accordance with a third embodiment of the present invention, a tape for sealing a package includes a laminate layer, a reinforcing strip in contact with the laminate layer, and indicia positioned to be visible when the reinforcing strip is separated from the laminate layer.

In accordance with a fourth embodiment of the present invention, a system for sealing packages includes a tape dispensing apparatus having cutter, and a tape dispensed from the dispensing apparatus having a predetermined length cut by the cutter. The tape includes a laminate layer having a pressure sensitive adhesive and a reinforcing strip for reinforcing the laminate layer, for increasing a resistance to tearing during package handling by a user, and for providing a tear strip to separate the laminate layer.

### BRIEF DESCRIPTION OF THE DRAWINGS

The foregoing aspects and other features of the present invention are explained in the following description, taken in connection with the accompanying drawings, wherein:

FIG. 1 shows a schematic perspective view of a system for easy opening sealed packages which incorporates features of the present invention, and a package;

FIG. 2 shows a schematic elevation view of a tape dispensing apparatus with a roll of tape of the system in FIG. 1;

FIGS. 3A-3B show respectively a front elevation view and a side elevation view of a cutting blade of the tape dispensing apparatus in FIG. 2;

FIG. 3C shows a partial plan view of the cutting blade mounted in the tape dispensing apparatus;

FIGS. 4A-4B show respectively a side elevation view, and a rear elevation view of a moisture shield of the tape dispensing apparatus in FIG. 2;

FIG. 4C shows a partial perspective view of the tape dispensing apparatus, showing the arrangement of the moisture shield relative to the tape fed by the tape dispensing apparatus and the water tray of the apparatus;

FIGS. 5A and 5B show one embodiment of a section of tape in accordance with the invention;

FIGS. 6A-6D show another embodiment of a tape in accordance with the invention;

FIGS. 7A-7D show yet another embodiment of a tape in accordance with the invention;

FIGS. 8A-8D show still another embodiment of a tape in accordance with the invention;

FIG. 9 shows a plan view of a tape cut into sections;

FIG. 10 shows still another plan view of a tape cut into sections; and

FIG. 11 shows features of the tape that provide security measures.

### DETAILED DESCRIPTION OF THE EMBODIMENTS

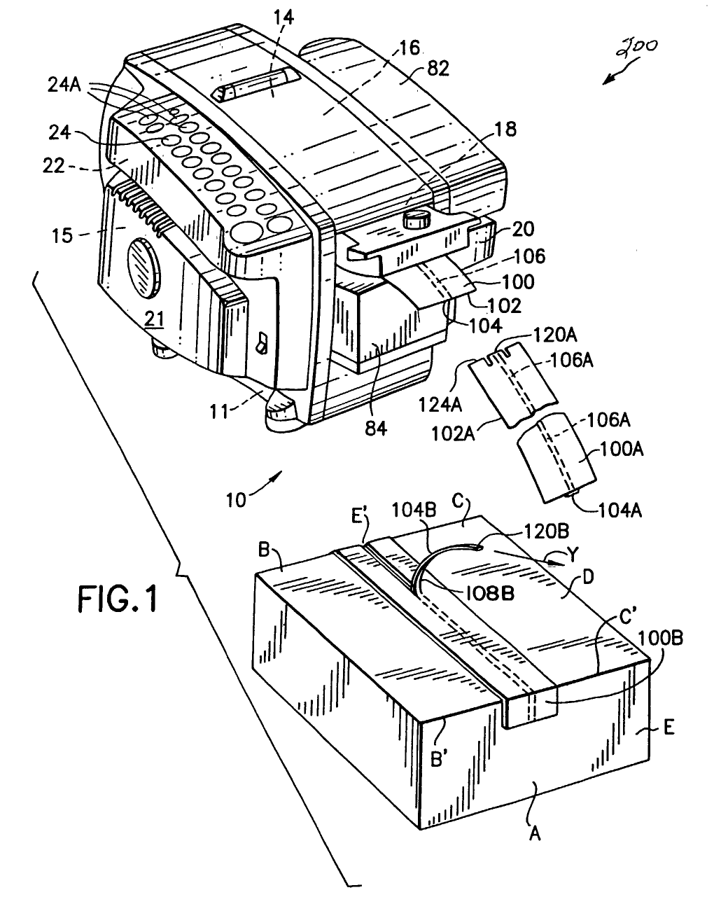

Referring to FIG. 1, there is shown a sealing tape 100 and a tape dispensing system 105 and a package A incorporating features of the present invention. Although the present invention will be described with reference to the embodiments shown in the drawings, it should be understood that the present invention may be embodied in many alternate forms. In addition, any suitable size, shape or type of elements or materials could be used.

Package A, as shown in FIG. 1, may be a carton having a general hexahedron shape. Package A may have at least two generally rectangular flaps B, C on at least one side D. When flaps B and C are folded closed, a seam E′ is formed between the flaps. Seams B′, C′ are also formed between the folded flaps B, C and one or more of the adjoining sides E of package A. In alternate embodiments, package A may be of any other suitable type or configuration, for example, an envelope, container, carton, etc. that may require sealing.

Tape 100 is generally stored in and dispensed from tape dispensing apparatus 12. Tape 100 may have an adhesive underside 112. Tape 100 is cut by tape dispensing apparatus 12 into sections, such as for example, section 100A, 100B, having a desired length to be used, for example, for sealing seam E′ on package A.

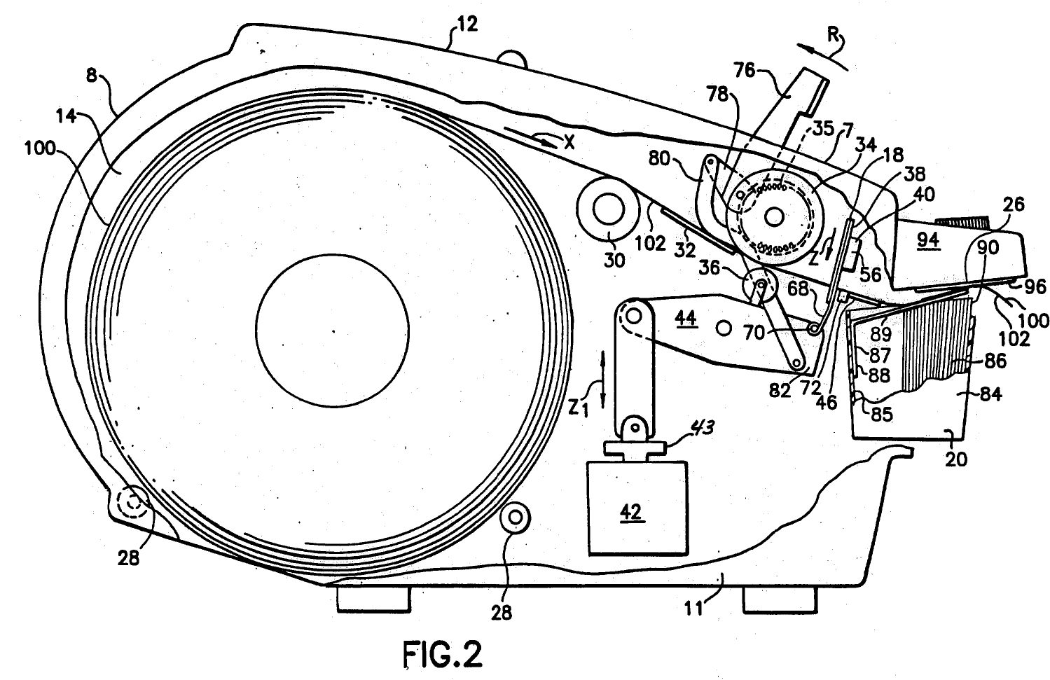

In greater detail, and with reference now also to FIG. 2, tape dispensing apparatus 12 generally comprises a frame 11, a tape storage area 14 defined in frame 11, a tape feeding mechanism 16, a cutting section 18, and optionally, a wetting system 20. Wetting system 20 may not be required or may not be appropriate for certain types of tape 100, for example, those with certain types of pressure sensitive or pre-activated adhesive.

Feeding mechanism 16, cutting section 18, and wetting system 20 are mounted to frame 11. Housing 21 covers frame 11. Tape dispensing apparatus 12 has an exit 26 through which tape 100 is dispensed. Tape 100 is stored in tape storage area 14. Feeding mechanism 16 draws tape 100 out of storage area 14 and feeds it past cutting section 18 and, if present, past wetting system 20 to activate an adhesive. Tape 100 is then drawn to exit 26, through which tape 100 is dispensed from apparatus 12. Tape 100 is cut to a desired length by cutting section 18.

Apparatus 12 may include a programmable controller 22 which is controllably connected to feeding mechanism 16, cutting section 18, and wetting system 20. A user interface 24 is provided to allow a user to interface with controller 22. In one embodiment, the user interface 24 may have function keys 24A, used by the user to input commands, such as for example, “Start/Stop”, and for identifying the dispensed tape lengths to the controller 22. In alternate embodiments, user interface 24 may use any other input means such as a touch display, or PC keyboard for providing commands to controller 22.

Tape storage area 14 is generally located towards a rear portion 8 of frame 11. Tape 100 may be provided in a roll and storage area 14 may be sized and shaped to hold a roll of tape 100. The roll may be positioned vertically in frame 11. In alternate embodiments, tape 100 may be stored in the storage area in any other suitable position or configuration, for example, horizontally stacked strips. Tape storage area 14 is provided with support rollers 28 which support the roll of tape 100 stored therein. The roller configuration shown in FIG. 2 is merely for example purposes, and support rollers 28 may be arranged in any other suitable configuration. Support rollers 28 are disposed to aid relatively unencumbered rotation of the roll of tape 100 when feed mechanism 16 draws tape 100 out of storage area 14.

Feeding mechanism 16 generally comprises idler rollers 30, guide trays 32, feed roller 34, pinch roller 36, and drive motor 15. Idler rollers 30 (only one idler roller 30 is shown in FIG. 2 for example purposes) are located between tape storage area 14 and feed roller 34. Idler rollers 30 support and guide tape 100 in a feed direction indicated by arrow X to feed roller 34.

As shown in FIG. 2, one or more guide trays 32 are mounted to frame 11 in the proximity of feed roller 34. Guide trays 32 are shaped and orientated such that tape 100 riding upon guide trays 32 is orientated true to feed direction X of feed mechanism 16, and aligned with feed roller 34. This prevents tape 100 from being skewed or twisted during feeding.

Feed roller 34 may be located towards a front portion 7 of apparatus 12. Feed roller 34 is drivingly connected to electric motor 15 (FIG. 1) by suitable transmission means (not shown) such as a belt, or chain drive. Electric motor 15 is energized under control of controller 22, and when energized rotates feed roller 34 in a suitable direction (e.g. counterclockwise) to transport tape 100 in feed direction X.

Friction contact between feed roller 34 and tape 100 causes movement of tape 100. Friction contact between tape 100 and feed roller 34 may be enhanced by a pinch roller 36, located opposite feed roller 34. When in an engaged position as shown in FIG. 2, pinch roller 36 presses tape 100 against feed roller 34 thereby increasing the friction force between them. Feed roller 34 may be connected to a counter 35 which can indicate the rotation of the feed roller, and hence, an amount of tape being fed. Counter 35 may be operable to convey this information to controller 15.

Feeding mechanism 16 described above and shown in FIGS. 1 and 2 is merely one example of a suitable feeding mechanism which may be used in tape dispensing apparatus 12 according to the present invention. The present invention is equally applicable to dispensing apparatus having any other suitable feeding mechanism such as, for example, a manually operated feeding mechanism, or a feeding mechanism adapted to feed tape with a pre-activated adhesive.

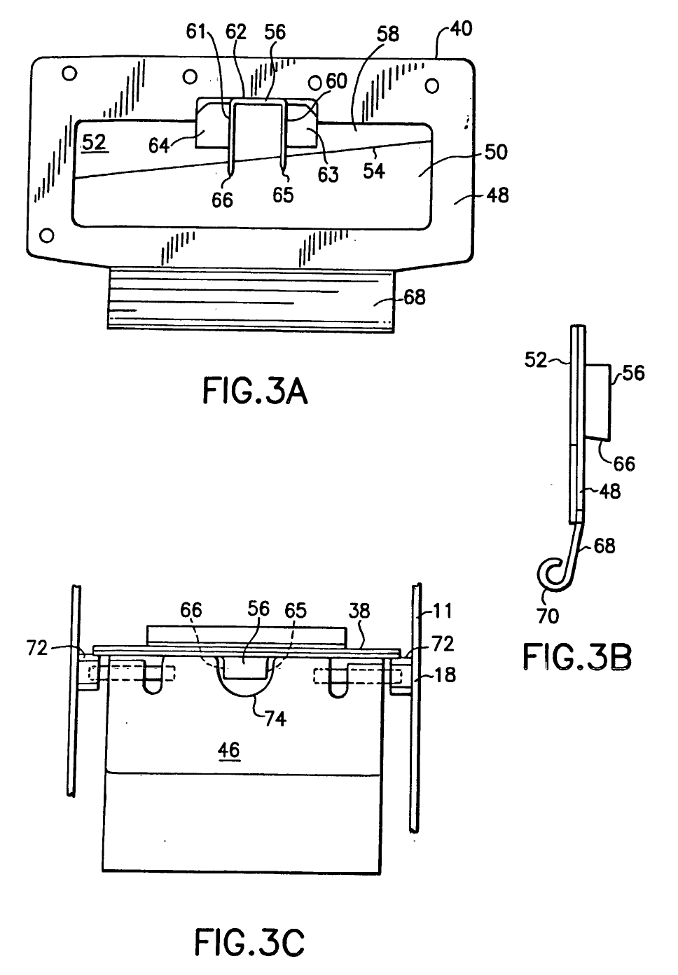

Referring also to FIG. 3C, cutting section 18 includes a cutting mechanism 38. Cutting mechanism 38 is operated by controller 22 to cut tape 100 fed past cutting section 18, and generally comprises support tray 46, cutting blade 40, spring loaded solenoid 42, and pivot link 44. Cutting blade 40 may be made of metal and is shown in greater detail in FIGS. 3A and 3B. Cutting blade 40 may include a frame member 48, and a blade member 52. Blade member 52 is substantially flat and has a cutting edge 54. A blade tab 56 is mounted to a side 58 of blade member 52.

Blade tab 56 may be a one piece member which could be stamped, or cut from suitable sheet metal. Blade tab 56 has a general U-shape with two sidewalls 60, 61 connected by a bottom wall 62. Alternatively, blade tab 56 may have any other suitable shape, such as for example, a V shape, a U shape, etc.

In a one embodiment, sidewall 60 is shorter than sidewall 61. Each sidewall 60, 61 has a corresponding mounting tab 63, 64, cantilevered therefrom as shown in FIG. 3A. A free edge of each sidewall 60, 61 is sharpened to form a cutting edge 65, 66.

In one embodiment, blade tab 56 is mounted to blade member 52 by seating and spot welding or brazing the mounting tabs 63, 64 to side 58 of blade member 52. As shown in FIG. 3A, blade tab 56 is mounted on blade member 52 with cutting edges 65, 66 pointed in the same direction (i.e. down) as cutting edge 54 of blade member 52. With blade tab 56 mounted to blade member 52, cutting edges 65, 66 are located to project somewhat below cutting edge 54, and also to project generally perpendicular from cutting edge 54 of blade member 52.

In alternate embodiments, blade member 52 and blade tab 56 may be connected in any other suitable manner. For example, blade member 52 and blade tab 56 may be formed as an integral unit by casting or forging blade member 52 into the desired shape. As shown in FIGS. 3A and 3B, blade member 52 is mounted to a side of frame member 48. Blade member 52 may be connected to frame member 48 by spot welding, brazing, mechanical fastening, or any other suitable method. Cutting edges 54, 65, 66 of blade member 52 and blade tab 56 are exposed in an interior opening 50 of frame member 48. Blade member 52 is mounted to frame member 48 to position cutting edge 54 at an angle in opening 50, for example, like that of a guillotine. Frame member 48 has a lower arm member 68 depending from one side. Lower arm member 68 terminates in a sleeve 70.

While discussed in the context of being made of metal, it should be understood that cutting blade 40, frame member 48, blade member 52, blade tab 56, and their various components, edges, and surfaces may be made of any material or combination of materials, for example, ceramic, composite, glass filled plastic, steel, aluminum, or any other suitable material or combination of materials.

As can be seen in FIGS. 2 and 3C, cutting blade 40 is slidably supported in frame 11 by guide rails 72. Guide rails 72 allow cutting blade 40 to slide in the direction indicated by arrow Z between an up position (shown in FIG. 2), and a down position (not shown).

Cutting blade 40 may be orientated generally transverse to tape 100 as the tape 100 is being fed by feed mechanism 16 past cutting blade 40. For example, cutting blade 40 may be generally perpendicular to support 46. In addition, cutting blade 40 is positioned in frame 11 such that tape 100 is fed through opening 50 frame member 48 when cutting blade 40 is in the up position, and when in the down position, cutting edge 54 cuts completely through tape 100. Support tray 46, which supports tape 100 and prevents it from buckling during the down stroke of cutting blade 40, has a cut out 74. Cutout 74 allows cutting edges 65, 66 on blade tab 56 to pass by support tray 46, and hence, cut into tape 100. As can be seen in FIG. 2, cutting blade 40 may be mounted in frame 11 with blade tab 56 projecting forward from blade member 52 of cutting blade 40.

Lower arm member 68 of cutting blade 40 is connected by a pin 70 to one end of pivot link 44. Pivot link 44 is pivotably mounted to frame 11. The opposite end of pivot link 44 is connected to an actuator 43 of a spring loaded solenoid 42. Spring loaded solenoid 42 is controlled by controller 22 (FIG. 1) and operates to move actuator 43 generally up and down. The up and down motion of actuator 43 is transferred to cutting blade 40 by pivot link 44. By way of example, cutting blade 40 may initially be in a down position (not shown), actuator 43 may be in an up position, and solenoid 42 may not be energized. When solenoid 42 is energized under control of controller 22, actuator 43 moves a down position which pivots pivot arm 44 to move the cutting blade 40 to the up position shown in FIG. 2. De-energizing the solenoid 42 again causes the spring loaded solenoid 42 to return actuator 43 to its up position which, via pivot link 44, in turn moves the cutting blade 40 back to its down position. As shown in FIG. 2, pinch roller 36 of the feeding mechanism 16 may also be mounted off the pivot link 44 such that when the solenoid 42 is energized the pinch roller 36 is moved up to press the tape against the feed roller, and when the solenoid 42 is de-energized, the pinch roller 36 is moved down to release the tape (not shown). In alternate embodiments, the cutting blade may be moved up and down by any other suitable means such as directly driving the blade with a compressed air or fluid piston.

Apparatus 12 may be provided with a lift arm 76 for manually raising and lowering cutting blade 40 in frame 11. Lift arm 76 is pivotably connected to frame 11 so that lift arm 76 may be rotated between a lowered position and a raised position (lift arm 76 is shown in the raised position in FIG. 2 for example purposes). Lift arm 76 is connected to a crank member 78 at one end. Crank member 78 is connected via link 80 to the same end 82 of pivot link 44 connected to cutting blade 40. Cutting blade 40 may thus be raised and lowered manually by raising and lowering lift arm 76. By way of example, when cutting blade 40 is in the down position (not shown), which is the initial position of cutting blade 40 when solenoid 42 is de-energized, lift arm 76 is in a down position (not shown). In order to raise cutting blade 40 without energizing solenoid 42, lift arm 76 is raised by rotating it in the direction indicated by arrow R in FIG. 2, to an up position. This in turn raises (via link 80) end 82 of pivot link 44 to which cutting blade 40′ is connected, thereby sliding cutting blade 40 to the up position shown in FIG. 2. In alternate embodiments, tape dispensing apparatus 12 may include any other suitable means for manually moving cutting blade 40.

Referring now to FIGS. 1, 2, and 4C, the optional wetting system 20 of apparatus 12 generally comprises a fluid reservoir or bottle 82, a basin or tray 84, a wetting brush 86 and a moisture shield 88. Tray 84 is mounted to the front portion 7 of frame 11, and is open at the top. Tray 84 of wetting system 20 holds a suitable wetting fluid for activating an adhesive on tape 100. Bottle 82 holds a wetting fluid reserve. Bottle 82 may be mounted external to housing 21 to feed reserve wetting fluid into tray 84 at a suitable rate to replenish the fluid therein. Reserve bottle 82 may be removable, allowing reserve bottle 82 to be removed at a suitable time and refilled without interrupting operation of tape dispensing apparatus 12.

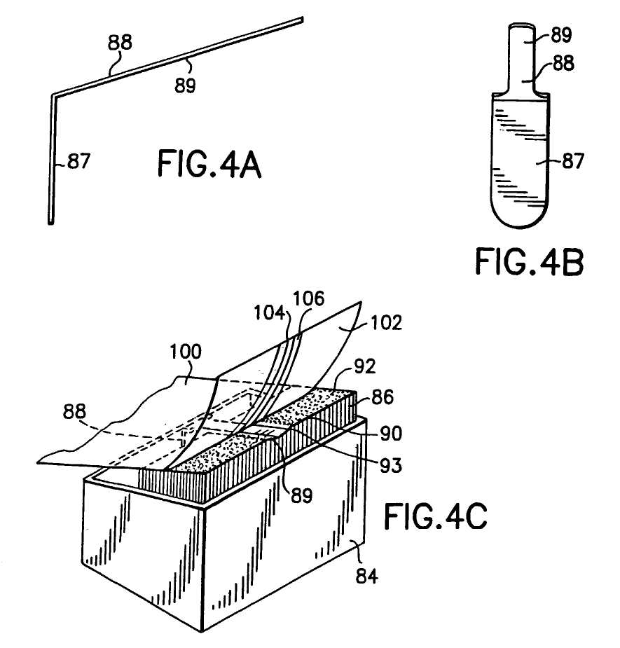

Wetting brush 86 is located inside tray 84. A top 90 of brush 86 projects above a lip of tray 84 (see FIG. 4C). The bottom of brush 86 sits in fluid in tray 84. Brush 86 is made of a material suitable for allowing fluid to be drawn by capillary action from tray 84 along the bristles of brush 86 to the top 90 of brush 86. The bristle density in brush 86 is sufficient to provide top 90 of brush 86 with a consistent wetting surface 92. Brush 86 is located in tray 84 so that the wetting surface 92 of brush 86 is generally coincident with the bottom surface of tape 100 being dispensed through exit 26 of apparatus 12 (see FIGS. 2 and 4C). Accordingly, when tape 100 is dispensed through exit 26, the bottom surface of tape 100 contacts wetting surface 92 of wetting system 20.

Apparatus 12 may be provided with a heater element 94 (see FIGS. 1 and 2). Heater element 94 may have a heating plate 96 which is disposed over wetting surface 92. The position of heating plate 96 may be adjusted vertically to bring heating plate 96 into contact with wetting surface 92. Heating plate 96 thus directly warms wetting surface 92 and, via heat transfer through the wet bristles of brush 86, warms the fluid in tray 84. Heating plate 96 may be raised away from wetting surface 92 when tape 100 is being dispensed from apparatus 12 and being wetted from wetting surface 92. In this case, thermal inertia of the fluid in tray 84 maintains the temperature of wetting surface 92 for a desired period of time. In alternate embodiments, the fluid in tray 84 may be heated by any other suitable means.

As can be seen in FIGS. 2 and 4C, wetting system 20 has a shield 88 for selectively wetting portions of the bottom of tape 100 dispensed from apparatus 12. Referring now also to FIGS. 4A and 4B, shield 88 may be a one piece member made from a sheet of suitable material, for example, stainless steel, though any other suitable material may be used including plastic. Shield 88 has a base member 87, and a tab or arm 89 depending therefrom. In alternate embodiments, shield 88 may have any other suitable configuration. For example, the arm depending from the base may not be flat, but could have a general V or U-shaped cross section, or any other suitable cross section.

Shield 88 may be mounted to tray 84. Base member 87 of shield 88 is disposed against a rear side 85 of tray 84. In alternate embodiments shield 88 may be mounted to any other side of tray 84, or may be mounted off frame 11 of apparatus 12. Base member 87 is clamped or fastened to tray 84 by any suitable means (not shown). Arm 89 of shield 88 is biased against the top 90 of brush 86 in tray 84. This presses a strip 93 of the top 90 of brush 86 below wetting surface 92. Shield 88 is positioned on tray 84 so that arm 89 generally bisects wetting surface 92.

When tape 100 is dispensed from tape apparatus 12, the bottom of tape 100 comes in contact with wetting system 92 but is otherwise prevented by shield arm 89 from contacting strip 93 on the top of brush 86. Thus, as the bottom of tape 100 passes across the top 90 of brush 86, the bottom of tape 100 has a strip along its middle which is generally unwetted, while the sections of the bottom of tape 100 on either side are wetted by wetting system 20.

Tape apparatus 12 may also have a folding, or crease forming mechanism (not shown) which forms tape section 100A dispensed from tape apparatus 12 into, for example, a general V-shape or U-shape (not shown) with the strip (similar to strip 106A of tape section 100A) being located at the bottom of the V or U. This shape, by increasing longitudinal rigidity of the tape, renders the tape self supporting when emerging from the dispensing apparatus exit thereby preventing the tape with adhesive from drooping down and from contacting a bench or table top (not shown) that may be supporting the apparatus. Moreover, the V or U shape facilitates aligning strip 106A of tape section 100A with the seam of package A to which tape section 100A is being applied. Alternately, the folding, or crease forming mechanism may form tape section 100A into any shape suitable for providing support or for facilitating alignment.

Once aligned with the seam, tape section 100A may be pressed against package A so that adhesive 108 bonds tape section 100A to package A and seals the seam.

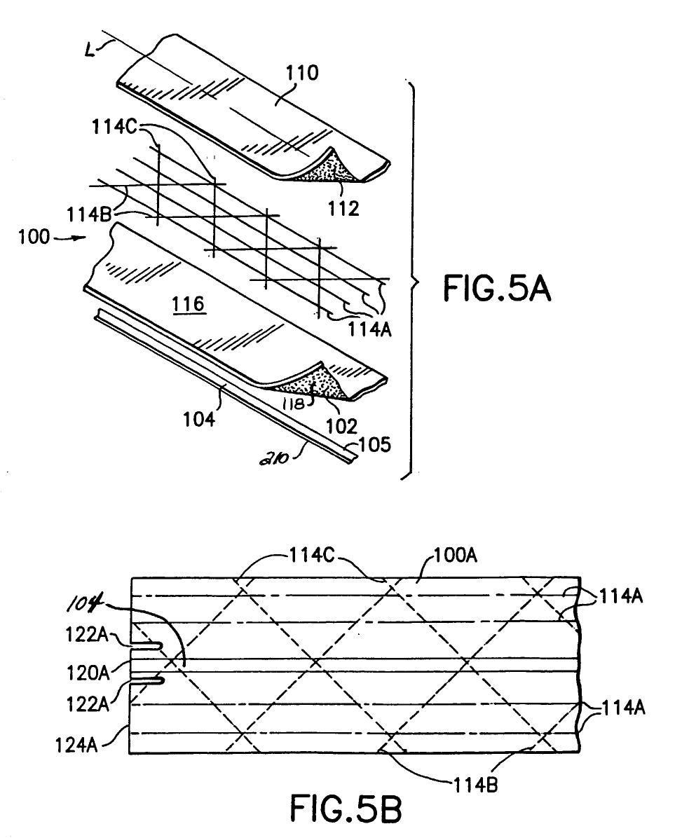

Referring now to FIGS. 1, 4C, and 5B, a user may, dispense tape 100 from dispensing apparatus 12 as described below. As noted above, tape 100 is loaded into storage area 14 in a roll configuration. Water may be added to optional wetting system 20 if wetting system 20 is present and required for wetting tape 100. A user energizes apparatus 12 which initiates controller 22. Using user interface 24, the user may program controller 22 to dispense tape 100 into sections such as sections 100A having a desired length. Controller 22 then energizes spring loaded solenoid 42, and activates feed system motor 15. When solenoid 42 is energized, cutting blade 40 which is initially down, is moved by link 44 to the up position (see FIG. 2). Link 44 also raises pinch roller 36 to press tape 100 against feed roller 34. Feed system 16 operates to feed tape 100 through opening 50 of cutting blade 40 (see FIG. 3A) which now is in the up position. If wetting system 20 is present and being utilized, tape 100 continues in the feed direction (indicated by arrow X in FIG. 2) to wetting system 20. Tape 100 is configured in storage area 14 of apparatus 12 so that when tape 100 reaches tray 84 of wetting system 20, bottom surface 112 with adhesive 102 faces the top 90 of wetting brush 86 (see FIG. 4C). Shield 88 is generally aligned with ribbon 104 of tape 100. Arm 89 is sufficiently wide to cover ribbon 104. As tape 100 is being fed, wetting surface 92 of brush 86 brushes against surface 102 of tape 100, except in the area of shield arm 89. Shield arm 89 prevents a portion of bottom surface 112 of tape 100 from coming into contact with brush 86. This forms a strip 106 as the tape 100 is fed where surface 112 is not wetted (see FIG. 4C). Ribbon 104 of tape 100 is located on strip 106. Moisture from wetting surface 92 deposited on tape 100 activates adhesive 102 except on strip 106. If desired, heater element 94 may have been previously activated to heat the water in tray 84 and on brush 86 to a desirable temperature. This enhances the activation of adhesive 102 on surface 112 except on strip 106. The moisture activated adhesive 102 in the area of strip 106 remains dry and inactive. When controller 22 senses, from counter 35, a desired length of tape 100 has been dispensed, controller 22 de-energizes spring loaded solenoid 42. This brings cutting blade 40 down and cuts tape 100 into a section such as section 100A (see also FIG. 5B). Cutting blade 40 cuts tape 100 transversely across, to form a tape section 100A.

FIGS. 5A and 5B show an exploded perspective view and a top plan view, respectively of one embodiment of tape 100 in accordance with the present invention. Though the description of the various embodiments of the invention will be with particular reference to tape 100, sections 100A and 100B of tape 100 are substantially similar.

In this embodiment, tape 100 may be reinforced paper tape. Tape 100 generally has a top layer 110, a pressure contact layer 112, reinforcing strands 114A-114C, a bottom layer 116, a lower surface 102, an adhesive 118, and a ribbon 104. Top layer 110, and bottom layer 116 may be made of suitable paper, such as for example, virgin kraft, high tensile paper having a 24 lb. basis weight, though any other suitable paper may be used. In alternate embodiments, top and bottom layers 110, 116 may be made of different paper, for example, top layer 110 may have heavier weight paper than bottom layer 116, or vice versa.

Top and bottom layers 110, 116 may be substantially the same width, and in one embodiment may be about 60 mm, although the present invention is equally applicable to tape of any width and length. Contact pressure layer 112 may be made of an amorphous polypropylene laminate material which is non-asphaltic, such as that made by Huntsman Chemical, though any other suitable pressure contact material may be used. Pressure contact layer 112 may be a flexible, water resistant, non-staining layer. Pressure contact layer 112 may also have a high melt point index with a softening point between about 180° and 200° F. In this embodiment, tape 100 has an array of reinforcing strands 114A-114C in three directions. In alternate embodiments, tape 100 may be reinforced in any number of directions, or may not be reinforced with reinforcing strands. Reinforcing strands 114A-114C may be made of fiberglass, or any other suitable strand material of appropriate tensile strength, including plastic, or organic fiber (e.g. cotton). Each strand 114A may be made from 150 denier fiberglass filament. Each strand 114B and 114C may be made from 450 denier fiberglass filament.

Ribbon 104 of tape 100 may be made from biaxially oriented polypropylene (BOPP), mono-axial polypropylene (MOPP), metallic ribbon, non-metallic carbon fiber, organic fiber, or any other suitable material. Ribbon 104 may have a width of about 2.5 to 3 mm, and a thickness of about 26 to 40 microns, though ribbon 104 may have any other suitable width and thickness dimensions. Ribbon 104 may be provided with a suitable self-adhesive on one side 105 and may have a bottom surface 210 that is adhesive free.

In this and other embodiments according to the invention, ribbon 104 serves as a reinforcing strip which provides tensile strength in a longitudinal direction for reinforcement of tape 100. Ribbon 104 also operates as a “tear strip” for the purpose of separating tape 100 into two or more pieces or for tearing tape 100 apart when opening package A (FIG. 1). Ribbon 104 may be free of adhesive on bottom side 210 which, in use, is applied to one or more seams B′ C′ E′ of package A. If bottom side 210 is free of adhesive, ribbon 104 does not adhere to the seam B′ C′ E′ of package A. When ribbon 104 is lifted from package A and peeled back along a longitudinal direction of tape 100, sufficient force is applied by ribbon 104 to tape 100 to tear tape 100 along the seam. If bottom side 210 is free of adhesive, ribbon 104 does not adhere to the seam B′ C′ E′ of package A and the lifting and peeling back of ribbon 104 operates to open package A.

As shown in FIG. 5B, tape 100 may include a start tab 120A to facilitate lifting ribbon 104. Start tab 120A may be located proximate an end 124A of a cut section of tape 100A. Start tab 120A is formed by two substantially parallel slits 122A in end 124A of tape section 100A. Slits 122A are formed on either side of ribbon 104. An area around start tab 120A on lower surface 102 is generally free of adhesive.

This embodiment of tape 100 may be manufactured as follows. Top layer 110, with pressure contact layer 112 thereon, reinforcing strands 114A-114C, bottom layer 116, and ribbon 104 are pressed together. Reinforcing strands 114A-114C are sandwiched between top and bottom layers 110, 116. Contact pressure layer 112 may be deposited on the underside of the top layer 110 (see FIG. 5A) before top and bottom layers 110, 116 are pressed together. Contact pressure layer 112 may be deposited on layer 110 using a hot melt method wherein the amorphous polypropylene material is melted and then applied by suitable means (not shown) in a layer of suitable thickness to the underside of top layer 110. When applied to top layer 110, contact pressure layer 112 forms an adhesive bond therewith. Contact pressure layer 112 is also in an adhesive state so that it may form an adhesive bond when pressed against bottom layer 116.

Reinforcing strands 114A-114C may be placed between top and bottom layers 110, 116 before top and bottom layers are joined together with pressure contact layer 112. As shown in FIG. 5B, reinforcing strands 114A-114C are laid out to provide three way reinforcement. In this embodiment, there are four strands 114A, oriented longitudinally, although any other suitable number may used in any orientation of tape 100. Longitudinal strands 114A may be distributed equally across the width of tape 100. Reinforcing strands 114B, 114C may be oriented diagonally across the tape at an angle about 42°, though any other suitable angle may be used. Reinforcing strands 114B extend in one direction, and strands 114C extend in a perpendicular direction forming a crossing pattern with strands 114B. Strands 114B, 114C crossing in each direction may be spaced at about 50 mm to 60 mm apart, though any other spacing may be provided between the crossing strands.

The tape layers 110, 112, 116, reinforcing strands 114A-114C, and ribbon 104 may be pressed together by any suitable means such as rollers (not shown). In combination with pressure, heat may be applied with appropriate means (not shown) in order to cure pressure contact layer 112 if desired and form a bond between top and bottom layers 110, 116. Reinforcing strands 114A-114C are thus sandwiched between top and bottom layers 110, 116 and are then substantially fixed in the matrix formed by the now set pressure contact layer 112.

As can be seen in the embodiment shown in FIG. 5A, the lower surface 102 of bottom layer 116 has adhesive 118 deposited thereon. In alternate embodiments, adhesive 118 may be deposited on the bottom of tape 100 during or after manufacture. Adhesive 118 may be a pressure sensitive adhesive. Adhesive 118 may include a variety of natural and synthetic materials, including natural rubber, synthetic rubber, block copolymers, acrylics, silicones, etc., modified in various ways through molecular weight selection, tackifier resin addition, oils, fillers, crosslinking agents, stabilizers, pigments and other additives. Adhesive 102 may also be pre-activated.

Adhesive 118 may also be moisture activated, such as, for example, an organic, non-toxic adhesive with a modified corn starch, smooth coat, high tack formulation. Adhesive 118 may also be any other suitable organic, or non-organic adhesive may be used.

Adhesive 118 may be deposited on bottom layer 116 by any suitable means, such as spraying, rolling, or brushing the adhesive onto the bottom layer. If adhesive 118 is in an inactive (i.e. non-adhesive) state when tape 100 is manufactured, adhesive 118 may be activated by adding heat and moisture during dispensing using wetting system 20.

Ribbon 104 may be pressed to surface 102 of bottom layer 116 when tape 100 is manufactured. In alternate embodiments, ribbon 104 may be deposited on lower surface 102 prior to or after tape manufacture. Ribbon 104 is applied to bottom layer 116 with self-adhesive side 105 against surface 117. Self-adhesive on side 105 thus connects ribbon 104 to lower surface 102 of tape 100. Ribbon 104 may be placed substantially along a center line L of tape 100. Ribbon 104 may be applied in a generally sinusoidal shape (not shown), substantially centered along centerline L in order to facilitate winding tape 100 into rolls. The sinusoidal shape may be shallow with a period of about 6″ to 12″ and an amplitude of about 1/16″. In alternate embodiments ribbon 104 may be applied generally straight.

Start tab 120A may be created by cutting blade 40 of tape dispensing apparatus 12 as it cuts tape 100 transversely across, to form tape section 100A. Start tab 120A is formed by edges 66, 65 of cutting blade 40 (FIG. 3A) which cut slits 122A into end 124A of tape section 100A (FIG. 5B). Start tab may also be formed by any other method suitable for forming slits in end 124A of tape section 100A.

The embodiment of tape 100 shown in FIGS. 5A and 5B may be manufactured within tape dispensing apparatus 12. Tape dispensing apparatus 12 may include additional storage areas and/or feeding mechanisms to accommodate and/or provide top layer 110, pressure contact layer 112, reinforcing strands 114A-114C, bottom layer 116, adhesive 118, ribbon 104, and additional mechanisms to assemble, press, heat, and/or perform other manufacturing processes for manufacturing tape 100. Alternately, top layer 110, pressure contact layer 112, reinforcing strands 114A-114C, bottom layer 116, adhesive 118, and ribbon 104 may be provided to tape dispensing apparatus 12 from external sources and tape 100 may be assembled and manufactured within tape dispensing apparatus 12.

Tape 100 can be manufactured in any suitable length such as 500 ft or more and can be wound in rolls for use with tape dispensing apparatus 12.

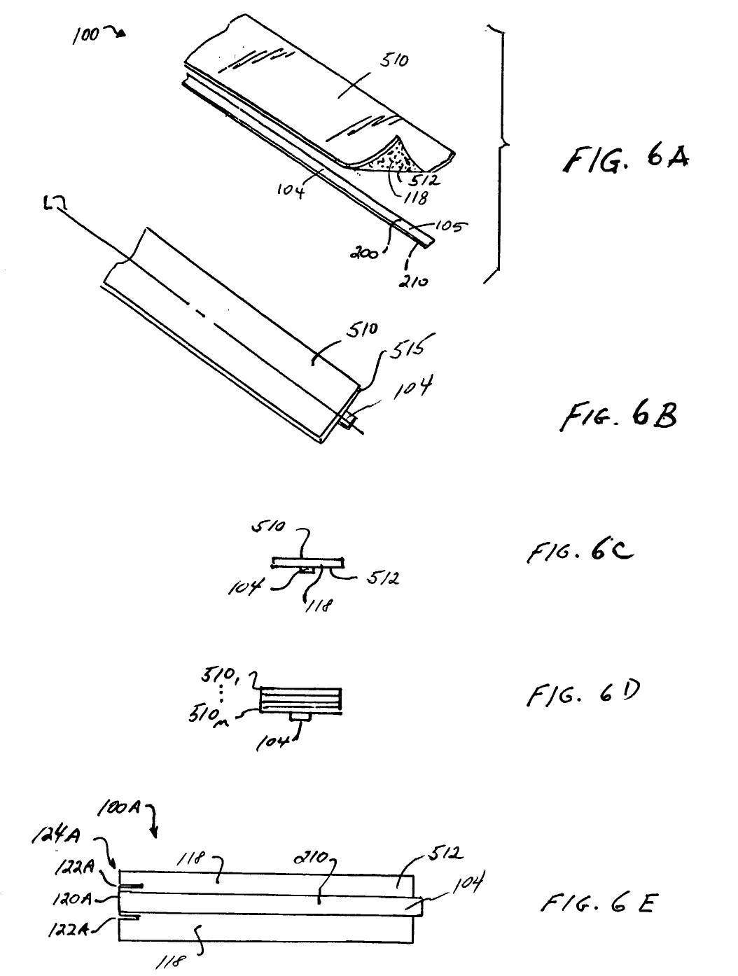

FIGS. 6A-6E show another embodiment of tape 100 in accordance with the present invention.

In this embodiment, tape 100 generally includes a top layer 510, a bottom surface 512, adhesive 118, described above, and ribbon 104. Like the embodiment in FIGS. 5A and 5B, top layer 510 may be about 60 mm, although the present invention is equally applicable to tape of any width and length. In this embodiment, according to the invention, top layer 510 is a laminate of one or more suitable materials, for example, paper, plastic, cloth, fiber, fiberglass, polymer, polypropylene, polyester, polyvinyl chloride, metal film, a polymer plastic film, a composite of plastic polymer and paper, or any combination of suitable materials.

Adhesive 118 may be a pressure sensitive adhesive as described above, and may be deposited on bottom surface 512 during or after manufacture of tape 100, by any suitable means, such as spraying, rolling, or brushing.

Ribbon 104 may be made as described above and may have any suitable width and thickness dimensions. In this embodiment, ribbon 104 is applied to bottom surface 512 of tape 100 and bonded to bottom surface 512 by adhesive 118. In another embodiment, ribbon 104 has a coating of adhesive 200 on top surface 105 for bonding to bottom surface 512 of tape 100. Adhesive 200 may be the same as adhesive 118 or may be a different adhesive. Bottom surface 210 of ribbon 104 is generally free of any adhesive. As shown in FIG. 6B, ribbon 104 may extend beyond a forward edge 515 of top layer 510. In an alternate embodiment, ribbon 104 ends flush with forward edge 515.

Like the embodiment shown in FIGS. 5A and 5B, in FIGS. 6A through 6E, ribbon 104 may be placed substantially along a center line L of tape 100. Ribbon 104 may be applied in a generally sinusoidal shape (not shown) which is substantially centered along centerline L in order to facilitate winding tape 100 into rolls, or may applied generally straight along centerline L.

Referring to FIG. 6E, this embodiment of tape 100 may also include a start tab 120A located proximate end 124A of cut section 100A. Two substantially parallel slits 122A are formed on either side of ribbon 104 to create start tab 120A. An area between slits 122A on bottom surface 512 is generally free of adhesive to facilitate lifting start tab 120A and a portion of ribbon 104 attached thereto. The action of lifting the portion of ribbon 104 applies force to tape 100 in an area of each slit 122A opposite end 124A of cut section 100A. In this embodiment, the concentration of force causes the laminate material of top layer 510 to fracture along the longitudinal edges of ribbon 104, allowing the laminate material to tear along the longitudinal edges and separate into two separate pieces.

The embodiment shown in FIGS. 6A-6E may be manufactured by producing top layer 510 as a laminate of one or more suitable materials. Top layer 510 may be produced by any suitable manufacturing process, for example, an extrusion or blowing process. For example, top layer 510 may include a single layer produced by extruding or blowing a laminate material. Ribbon 104 may also be manufactured, for example, by extruding or blowing, and may then applied to top layer 510. Top layer 510 and ribbon may be manufactured at the same time and may be pressed together. In another embodiment, top layer 510 and ribbon 104 may be manufactured together as a single extrusion. As another example shown in FIG. 6D, top layer 510 may comprise a number of layers 510l-510n of a single laminate material, or a number of layers of multiple types of laminate materials. Each layer may be extruded or blown separately, and then pressed together, may be manufactured together as a single extrusion, or may be manufactured as a combination of extrusions.

Adhesive 118 may be applied to bottom surface 512 during or after the production of top layer 510. Ribbon 104 may subsequently be applied to bottom surface 512 while maintaining bottom surface 210 free of any adhesive. In an alternate embodiment, adhesive 118 is applied to bottom surface 512 after the application of ribbon 104. Bottom surface 210 of ribbon 104 may be masked to prevent application of adhesive to bottom, surface 210. Start tab 120A may be formed cutting, melting, or otherwise forming slits 122A into end 124A of tape section 100A as shown in FIG. 6E.

The embodiment of tape 100 shown in FIGS. 6A-6E may be manufactured within tape dispensing apparatus 12. Tape dispensing apparatus 12 may include additional storage areas and/or feeding mechanisms to accommodate and/or provide top layer 510, adhesive 118, and ribbon 104, and additional mechanisms to assemble, press, heat, extrude, blow, and/or perform other manufacturing processes for manufacturing tape 100. Alternately, top layer 510, adhesive 118, and ribbon 104 may be provided to tape dispensing apparatus 12 from external sources and tape 100 may be assembled and manufactured within tape dispensing apparatus 12.

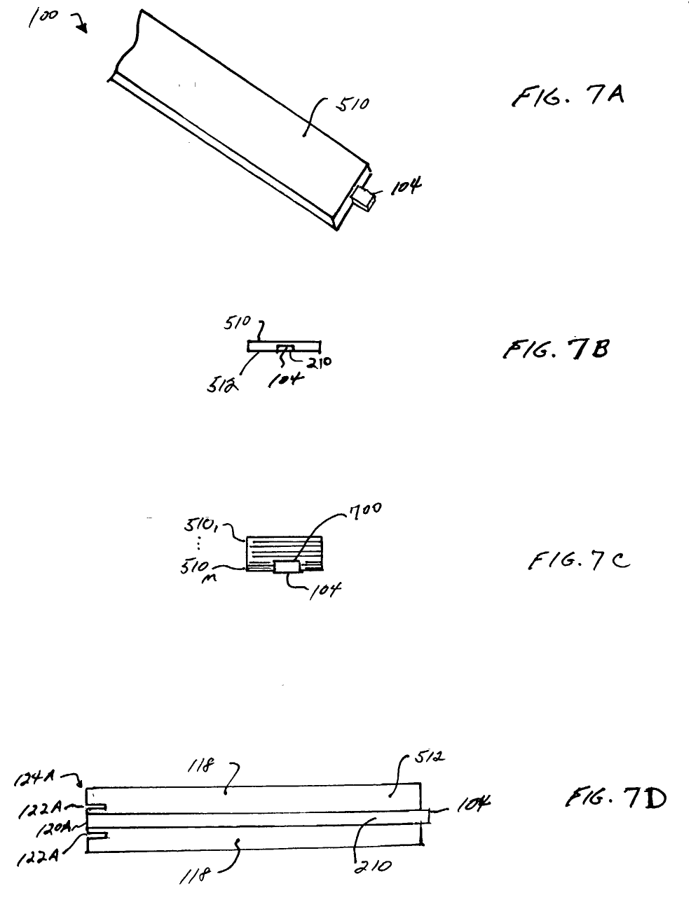

FIGS. 7A-7D show another embodiment of tape 100. In this embodiment, ribbon 104 is molded or otherwise embedded in top layer 510. Bottom surface 210 of ribbon 104 may protrude slightly from bottom surface 512 of top layer 510. In an alternate embodiment, bottom surface 210 of ribbon 104 may be flush with bottom surface 512 of top layer 510.

Referring to FIG. 7D, like other embodiments described herein, this embodiment of tape 100 may also include a start tab 120A located proximate end 124A of cut section 100A. Start tab 120A is created by forming two substantially parallel slits 122A on both sides of ribbon 104. An area proximate slits 122A and ribbon 104 on bottom surface 512 is generally free of adhesive to facilitate lifting start tab 120A. The action of lifting the portion of ribbon 104 applies force to tape 100 in an area of each slit 122A opposite end 124A of cut section 100A. As in other embodiments, the concentration of force causes the laminate material of top layer 510 to fracture along the longitudinal edges of ribbon 104, allowing the laminate material to tear along the longitudinal edges and separate into two separate pieces.

The embodiment shown in FIGS. 7A-7D may be manufactured by producing top layer 510 as a laminate of one or more suitable materials by any suitable manufacturing process, for example, an extrusion or blowing process. Top layer 510 may include a single layer (FIG. 7B) or multiple layers 510₁-510ₙ (FIG. 7C). Top layer 510 may be made of a single laminate material, or may be made of various laminate materials. The laminate or laminates may be extruded or blown separately, and then pressed together, or heated and pressed together. The embodiment of FIG. 7C may also be manufactured by extruding one or more laminate materials together at the same time.

The embodiment shown in FIGS. 7A-7D may also be manufactured by producing top layer 510 so as to form a slot 700 in which ribbon 104 may be pressed, molded, or otherwise applied. Adhesive 118 may be applied to bottom surface 512 during or after the production of top layer 510. Bottom surface 210 of ribbon 104 is masked to prevent application of adhesive to bottom surface 210. Start tab 120A may be formed cutting, melting, or otherwise forming slits 122A into end 124A of tape section 100A as shown in FIG. 7D.

The embodiment of tape 100 shown in FIGS. 7A-7D may be manufactured within tape dispensing apparatus 12. Tape dispensing apparatus 12 may include additional storage areas and/or feeding mechanisms to accommodate and/or provide top layer 510, adhesive 118, and ribbon 104, and additional mechanisms to assemble, press, heat, extrude, blow, and/or perform other manufacturing processes for manufacturing tape 100. Tape dispensing apparatus 12 may also include a molding or embedding capability for molding or embedding ribbon 104 in top layer 510. Alternately, top layer 510, adhesive 118, and ribbon 104 may be provided to tape dispensing apparatus 12 from external sources and tape 100 may be assembled and manufactured within tape dispensing apparatus 12.

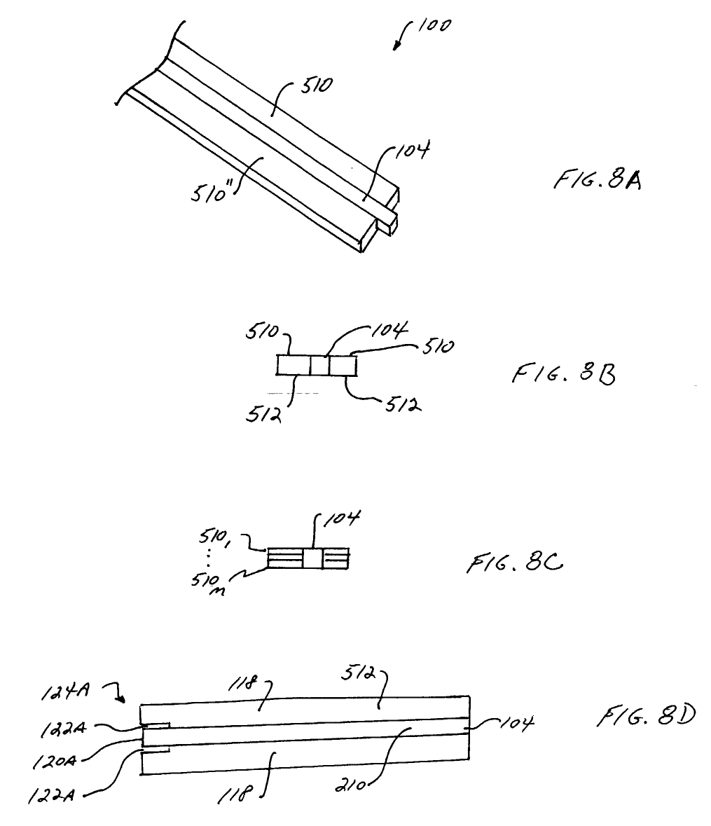

FIGS. 8A-8D show still another embodiment of tape 100. A suitable laminate of one or more materials as described above is provided as top layer 510. In this embodiment, ribbon 104 is formed as an integral part of tape 100, where top layer 510 is made of two parts 510′, 510″ joined together by ribbon 104. Ribbon 104 and top layer portions 510′, 510″ may have the same thickness. As shown in FIG. 8C, top layer 510 may comprise multiple layers 510₁ . . . 510ₙ of one or more materials. This embodiment of tape 100 may also include a start tab 120A as shown in FIG. 8D, located proximate end 124A of cut section 100A, created by forming two substantially parallel slits 122A on both sides of ribbon 104.

The embodiment shown in FIGS. 8A-8D may be manufactured by producing top layer 510 in two parts and joining them to opposite sides of ribbon 104 by, for example, gluing, melting, or any other bonding method. Adhesive 118 may be applied to bottom surface 512 during or after the production of top layer 510. Tape 100 is manufactured in a manner that ensures that bottom surface 210 of ribbon is free of adhesive.

The embodiment of tape 100 shown in FIGS. 8A-8D may be manufactured within tape dispensing apparatus 12. Tape dispensing apparatus 12 may include additional storage areas and/or feeding mechanisms to accommodate and/or provide top layer 510 in two parts 510′, 510″ adhesive 118, and ribbon 104, and additional mechanisms to assemble, press, heat, extrude, blow, and/or perform other manufacturing processes for joining the two parts 510′, 510″ and ribbon 104, and otherwise manufacturing tape 100. Tape dispensing apparatus 12 may also include a molding, extruding, blowing or other capability for manufacturing the two parts 510′, 510″ and ribbon 104, and for fusing, melting, assembling, or otherwise joining them together. Alternately, the two parts 510′, 510″ and ribbon 104 may be provided to tape dispensing apparatus 12 from external sources and tape 100 may be assembled and manufactured within tape dispensing apparatus 12.

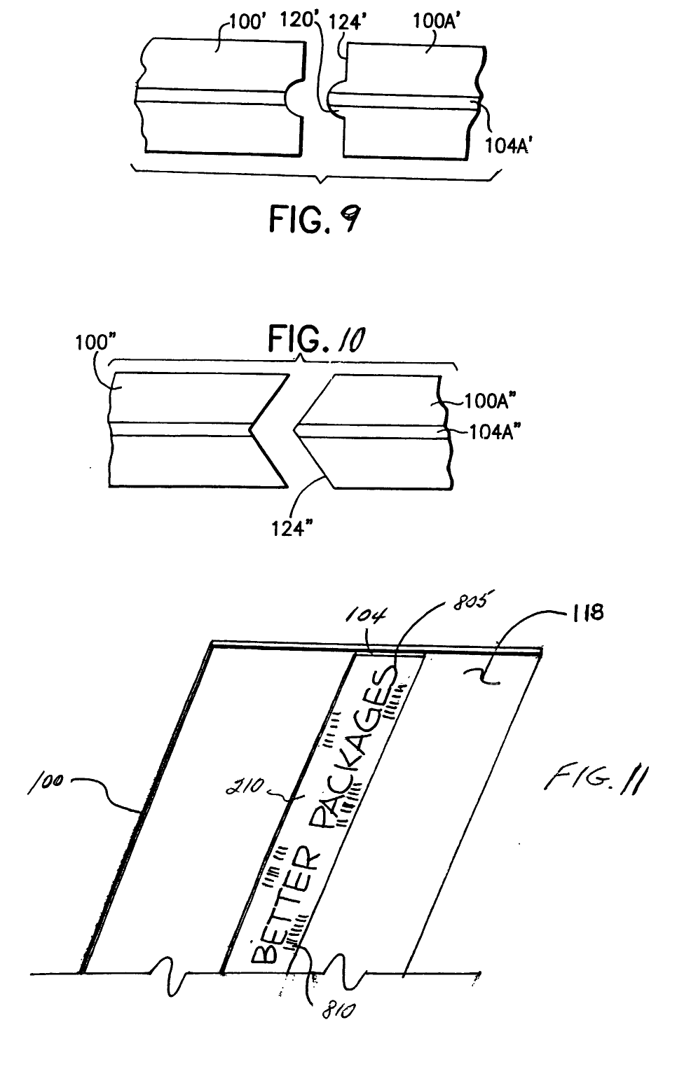

FIG. 9 shows a plan view of tape 100′ cut into sections in accordance with the present invention. Tape 100′ is substantially similar to tape 100 described previously and shown in FIGS. 1, 5A, 5B, 6A-6E, 7A-7D, and 8A-8D. Hence, similar features have similar numbers. Tape 100′ is cut when dispensed from tape dispensing apparatus 12 (FIG. 1) so that proximal end 124′ of cut section 100A′ has a start tab 120′ which projects from end 124′. Start tab 120′ has a generally semicircular configuration, though in alternate embodiments, start tab 120′ may have any other suitable shape.

FIG. 10 shows still another plan view of a tape 100″ cut into sections in accordance with the present invention. In this embodiment, proximal end 124″ of cut section 100A″ has a general V shape. The apex of V shaped end 124″ generally coincides with the location of ribbon 104A″ on tape 100A″.

Referring again to FIG. 1, the lifting of ribbon 104B from tape section 100B applied to package A, causes permanent, visible damage to tape section 100B in the form of an uplifted portion of ribbon 104B, and an uplifted and torn portion 108B of tape 100B. This provides an indication to a recipient user receiving package A, that package A may have been tampered with. Thus, it is also within the scope of the present invention to provide a security system 200 (FIG. 1) for packages, which may include tape dispensing apparatus 12 and tape 100, 100A, 100B. In one embodiment, tape 100B, applied to package A gives an indication to the user, such as by the torn portion 108B, that package A has been tampered with. Once portion 108B has been torn, tape section 100B cannot be restored to its original condition, and the evidence of tearing will remain visible to a user.

FIG. 11 shows features of ribbon 104 that provide for additional security measures in accordance with the teachings of the present invention. As shown, ribbon 104 includes indicia 805, 810 on bottom surface 210. Indicia 805, 810 are positioned such that they are only visible in the event that a portion of ribbon 104 is lifted from tape 100. An example of indicia 805 may include human readable indicia, for example, text. Another example of indicia 810 may include a non-human readable code, for example, a bar code or a material that fluoresces when exposed to certain wavelengths. Indicia 805, 810 may also include a graphic image, a color code, a watermark, an encrypted code, a hologram, or any other human readable, non-human readable, or machine readable indication.

Indicia 805, 810 may indicate tampering of package A, for example, with a message or other indication, readable or perceivable when at least a portion of ribbon 104 is lifted from tape 100. Indicia 805, 810 may also indicate a source or origin of tape 100, detectable only by incurring permanent, visible damage to tape 100 in the form of an uplifted portion of ribbon 104. For example, upon opening package A, a user or a machine may be able to view an indication verifying that a particular type of tape, or that tape from a particular manufacturer was used to seal package A. Conversely, the origin or type of tape may be undetectable without visibly and irreversibly damaging tape 100.

Once manufactured, tape 100 is applied to package A. Tape 100 may first be dispensed from tape dispensing apparatus 12.

During the dispensing process, tape 100 may be cut into sections 100A, 100B and tab 120A may be formed on at least one end of the tape section. Tape section 100A may be placed on package A with ribbon 104A generally aligned with seam E′ of package A. Ribbon 104A provides user indicia to aid in aligning tape section 100A with the open seam, that is, while applying tape 100, a user may view ribbon 104A and utilize the ribbon to align the tape section 100A along seam E′ to ensure proper sealing and closure of package A.

FIG. 1 shows tape section 100B applied to package A, such that ribbon 104A is generally aligned with seam E′ sealed by tape section 100B.

Because the portion of ribbon 104A contacting package A is free of adhesive, ribbon 104A does not adhere to package A when tape section 100B is bonded to close seam E′. Tab 120B is located at one end of tape section 100B, and to open seam E′, a user merely lifts and pulls on tab 120B in the direction indicated by arrow Y in FIG. 1. Pulling the start tab 120B, which has a portion of ribbon 104B thereon, in turn, pulls ribbon 104B thereby fracturing tape section 100B and opening seam E′.

Fracturing tape section 100B causes permanent, visible damage to tape section 100B in the form of an uplifted and torn portion of ribbon 104B. This may provide an indication to a recipient of package A that package A may have been tampered with by displaying a message or other perceivable indicia. The indicia may also indicate a source or origin of tape section 100B, detectable only when the permanent, visible damage to tape section 100B occurs.

Thus, utilizing the invention allows a package to be easily opened, and to be opened without damaging the package or its contents. The tab facilitates lifting the ribbon and applying force to the laminate, causing it to fracture and easily separate to open the package. The security features allow for detection of tampering and also allow for identification of the tape's origin.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A package closure tape assembly comprising:
a laminate layer having a pressure sensitive adhesive; and
a reinforcing strip for reinforcing the laminate layer, for increasing a resistance to tearing during package handling by a user, and for providing a tear strip to separate the laminate layer.

2. The package closure tape assembly of claim 1, wherein the laminate layer comprises a plurality of layers of one or more materials.

3. The package closure tape assembly of claim 1, wherein the laminate layer comprises reinforcing strands.

4. A method for closing a package comprising:
providing a laminate layer with a pressure sensitive adhesive and a reinforcing strip; and
applying the laminate layer on an open seam of the package wherein the reinforcing strip provides user indicia to aid in aligning the laminate layer with the open seam.

5. A tape for sealing a package comprising:
a laminate layer;
a reinforcing strip in contact with the laminate layer; and
indicia positioned to be visible when the reinforcing strip is separated from the laminate layer.

6. A system for sealing packages comprising:
a tape dispensing apparatus having a cutter; and
a tape dispensed from the dispensing apparatus having a predetermined length cut by the cutter, the tape including:
a laminate layer having a pressure sensitive adhesive; and
a reinforcing strip for reinforcing the laminate layer, for increasing a resistance to tearing during package handling by a user, and for providing a tear strip to separate the laminate layer.
